(19) United States
(12) Patent Application Publication
(10) Pub. No.: US 2021/0041536 A1
(43) Pub. Date: Feb. 11, 2021

(54) LIGHT SOURCE SYSTEM, METHOD OF MANUFACTURING DIFFRACTIVE OPTICAL ELEMENT, RANGING SYSTEM, AND DIFFRACTIVE OPTICAL ELEMENT

(71) Applicant: SONY SEMICONDUCTOR SOLUTIONS CORPORATION, KANAGAWA (JP)

(72) Inventor: KATSUJI KIMURA, KANAGAWA (JP)

(21) Appl. No.: 16/963,771

(22) PCT Filed: Mar. 4, 2019
(86) PCT No.: PCT/JP2019/008353

§ 371 Date: Jul. 21, 2020

(30) Foreign Application Priority Data
Mar. 19, 2018 (JP) 2018-050773
Oct. 30, 2018 (JP) 2018-203709

(51) Int. Cl. G01S 7/481; G01S 17/86; G01S 17/89; G02B 5/18

(52) U.S. Cl. CPC G01S 7/4816; G01S 17/86; G02B 5/1857; G02B 5/1814; G01S 17/89

(57) ABSTRACT

A light source system of the present disclosure includes: a light source that emits light; and a diffractive optical element that includes a diffraction grating section that is formed on one surface, has an opening in a predetermined pattern, the light from the light source entering the opening, and generates diffracted light on the basis of the entering light, and a zero-order light correcting section that is formed in at least part of region on another surface opposite to the one surface, the at least part of region corresponding to the opening as viewed from an entering direction of the light from the light source, and reduces zero-order light generated in the diffraction grating section.

### TECHNICAL FIELD

The present disclosure relates to a light source system, a method of manufacturing a diffractive optical element, a ranging system, and a diffractive optical element.

### BACKGROUND ART

In recent years, a solid-state imaging apparatus and a biometric authentication apparatus that perform biometric authentication such as facial recognition using a ranging function have been prevailing to prevent spoofing and fraud in electronic payment processing or the like using a mobile terminal apparatus with a built-in camera, a banking-service system, etc. As a method of achieving reduction in size and thickness, as well as enhanced performance in such apparatuses, a method has been commonly used that performs ranging and biometric authentication on the basis of diffracted light generated by a diffractive optical element (DOE) irradiated with infrared light serving as collimated light. For example, a method has been typically utilized that performs the ranging and the biometric authentication in such a manner that reflected light from an object irradiated with diffracted light is imaged, and the reflected light is analyzed after converting such imaged reflected light into image data.

### CITATION LIST

### Patent Literature

PTL 1: Japanese Unexamined Patent Application Publication No. 2013-190394

PTL 2: Japanese Unexamined Patent Application Publication No. 2015-115527

PTL 3: Japanese Unexamined Patent Application Publication No. 2015-132546

### SUMMARY OF THE INVENTION

In the above-described apparatuses, when the diffracted light is generated with use of the diffractive optical element, zero-order light and multi-order light are generated; however, the zero-order light and the multi-order light are different in light intensity. This hinders a zero-order light component from being accurately analyzed when the reflected light is imaged, possibly resulting in deterioration in accuracy of the ranging and the biometric authentication.

It is desirable to provide a light source system, a ranging system, and a diffractive optical element that allow for reduction in intensity of the zero-order light. Further, it is desirable to provide a method of manufacturing a diffractive optical element that makes it possible to manufacture the diffractive optical element that reduces the intensity of the zero-order light.

A light source system according to an embodiment of the present disclosure includes: a light source that emits light; and a diffractive optical element that includes a diffraction grating section that is formed on one surface, has an opening in a predetermined pattern, the light from the light source entering the opening, and generates diffracted light on the basis of the entering light, and a zero-order light correcting section that is formed in at least part of region on another surface opposite to the one surface, the at least part of region corresponding to the opening as viewed from an entering direction of light from the light source, and reduces zero-order light generated in the diffraction grating section.

A method of manufacturing a diffractive optical element according to an embodiment of the present disclosure includes: forming a light-blocking member in a predetermined pattern on one surface of a substrate; bringing liquid UV curable resin into contact with another surface opposite to the one surface of the substrate; irradiating the substrate with UV light from side of the one surface; and cleaning the other surface of the substrate.

A ranging system according to an embodiment of the present disclosure includes: a light source that emits light; a diffractive optical element that includes a diffraction grating section that is formed on one surface, has an opening in a predetermined pattern, the light from the light source entering the opening, and generates diffracted light on the basis of the entering light, and a zero-order light correcting section that is formed in at least part of region on another surface opposite to the one surface, the at least part of region corresponding to the opening as viewed from an entering direction of the light from the light source, and reduces zero-order light generated in the diffraction grating section; an imaging section that images reflected light of the diffracted light outputted from the diffractive optical element and emitted to an object, and generates image data; and a distance calculation section that calculates a distance to the object on the basis of the image data.

A diffractive optical element according to an embodiment of the present disclosure includes: a substrate; a diffraction grating section that is formed on one surface of the substrate, has an opening in a predetermined pattern which light enters, and generates diffracted light on the basis of the entering light; and a zero-order light correcting section that is formed in at least part of region on another surface of the substrate opposite to the one surface, the at least part of region corresponding to the opening as viewed from an entering direction of the light, and reduces zero-order light generated in the diffraction grating section.

In the light source system, the ranging system, or the diffractive optical element according to the embodiment of the present disclosure, diffracted light is generated by the diffraction grating section. The zero-order light correcting section reduces zero-order light generated in the diffraction grating section.

In the method of manufacturing a diffractive optical element according to the embodiment of the present disclosure, the diffractive optical element that makes it possible to reduce zero-order light is manufactured.

### BRIEF DESCRIPTION OF DRAWINGS

FIG. 1 is a configuration diagram schematically illustrating a configuration example of a light source system and a ranging system according to a first comparative example.

FIG. 2 is an explanatory diagram schematically illustrating an example of light intensity to be measured by the ranging system according to the first comparative example.

FIG. 3 is a configuration diagram schematically illustrating a configuration example of a light source system and a ranging system according to a second comparative example.

FIG. 4 is a configuration diagram schematically illustrating a configuration example of a light source system and a ranging system according to a first embodiment of the present disclosure.

FIG. 5 is a cross-sectional view and a plan view that schematically illustrate a configuration example of a diffractive optical element according to the first embodiment.

FIG. 6 is a process diagram illustrating an example of a method of manufacturing the diffractive optical element according to the first embodiment.

FIG. 7 is a cross-sectional view and a plan view that schematically illustrate a configuration example of a diffractive optical element according to a first modification example of the first embodiment.

FIG. 8 is a cross-sectional view and a plan view that schematically illustrate a configuration example of a diffractive optical element according to a second modification example of the first embodiment.

FIG. 9 is a configuration diagram schematically illustrating a configuration example of a light source system and a ranging system according to a second embodiment.

### MODES FOR CARRYING OUT THE INVENTION

Hereinafter, some embodiments of the present disclosure are described in detail with reference to the drawings. It is to be noted that descriptions are given in the following order.

### 1. First Embodiment

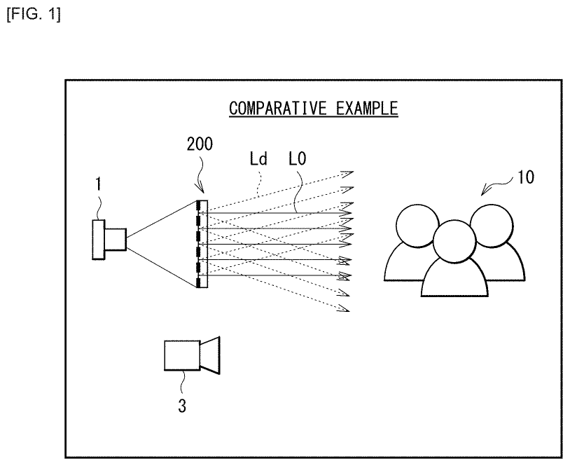

1.0 Comparative Examples (FIG. 1 to FIG. 3)

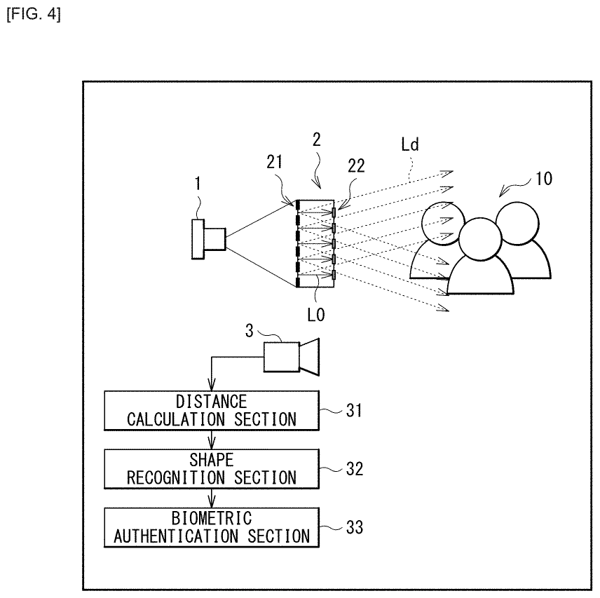

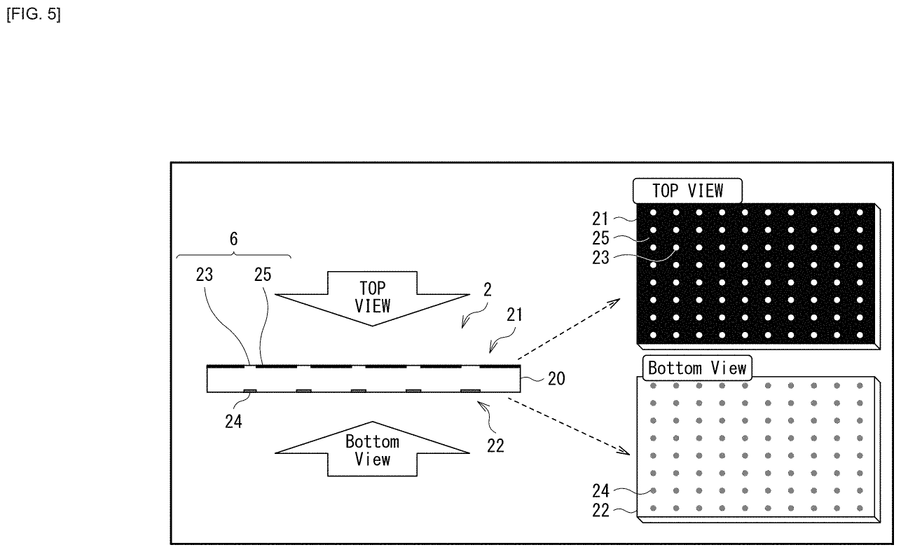

1.1 Configuration and Operation of Light Source System and Ranging System According to First Embodiment (FIG. 4 and FIG. 5)

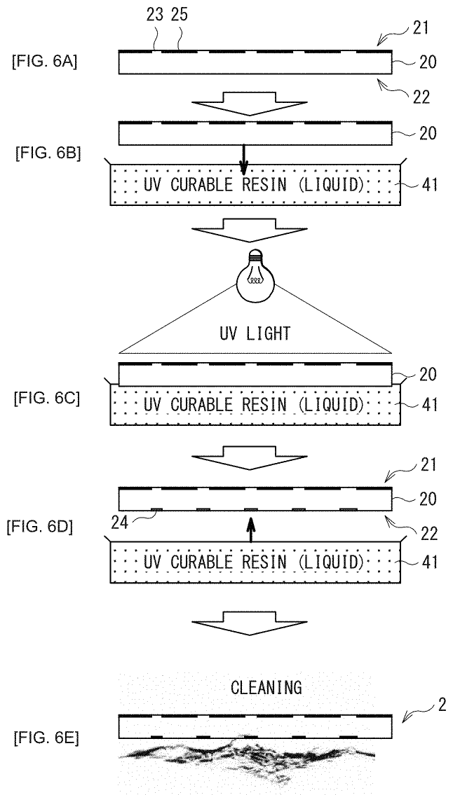

1.2 Method of Manufacturing Diffractive Optical Element According to First Embodiment (FIG. 6)

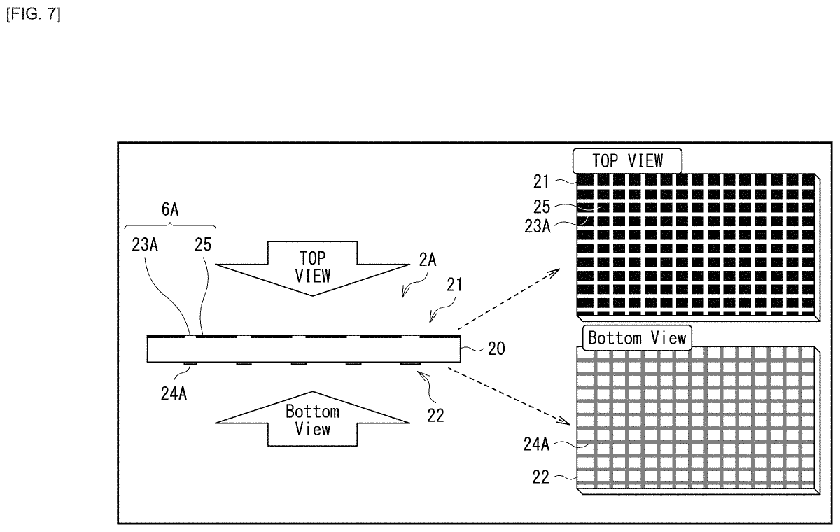

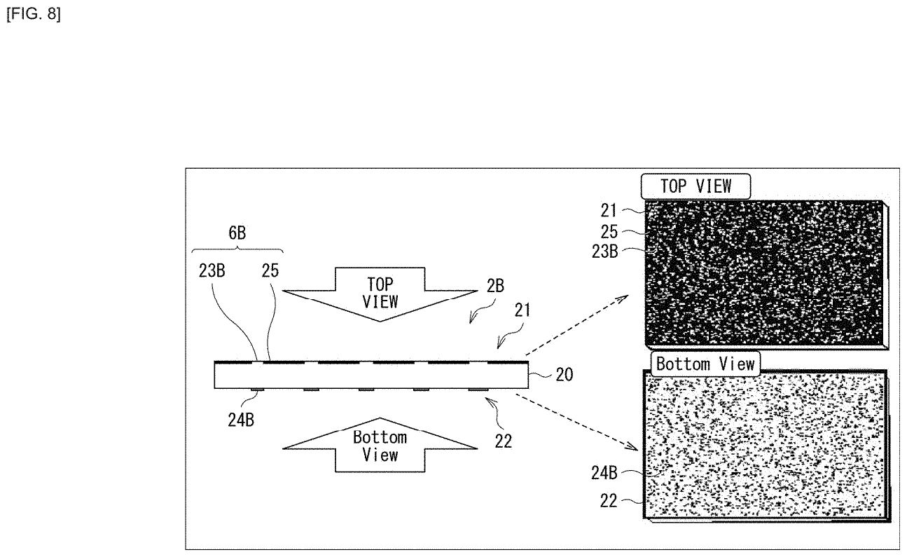

1.3 Modification Examples of Diffractive Optical Element According to First Embodiment (FIG. 7 and FIG. 8)

1.4 Effects

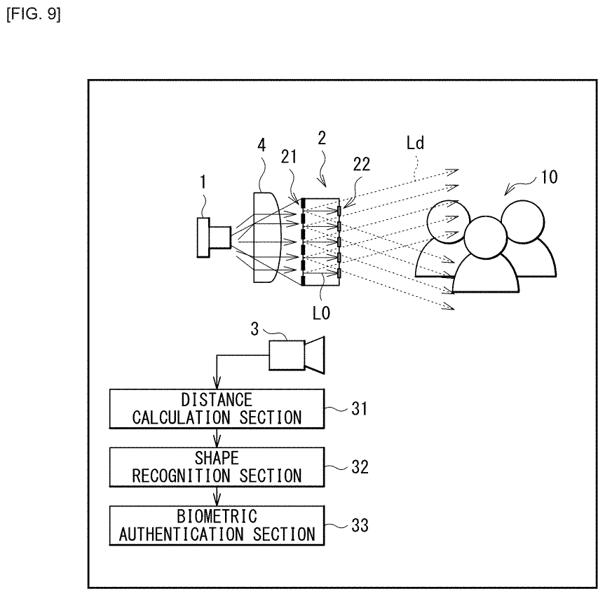

### 2. Second Embodiment (FIG. 9)

### 3. Other Embodiments

### 1. First Embodiment

The technology of the present disclosure relates to a ranging system that includes, for example, a chip size package (CSP) solid-state imaging device, such as a charge-coupled device (CCD) sensor and a complementary metal-oxide semiconductor (CMOS) image sensor; and a light source system that emits diffracted light for measuring a distance to an object. The light source system and the ranging system of the present disclosure are applicable to, for example, digital cameras such as a digital video camera and a digital still camera, image input cameras such as a surveillance camera and a vehicle-mounted camera, and electronic information apparatuses such as a scanner, a facsimile machine, a television phone, and a mobile terminal apparatus with a built-in camera. Further, the light source system and the ranging system of the present disclosure are also applicable to a biometric authentication apparatus and an inspection instrument.

### 1.0 Comparative Examples

PTL 2 (Japanese Unexamined Patent Application Publication No. 2015-115527) and PTL 3 (Japanese Unexamined Patent Application Publication No. 2015-132546) disclose working examples for making a commonly used distance measurement; however, such patent literature fail to describe any technology that solves an issue with light intensity resulting from a zero-order light component described above. In the technology described in PTL 1 (Japanese Unexamined Patent Application Publication No. 2013-190394), two solid-state imaging apparatuses are provided to avoid the issue with the light intensity resulting from the zero-order light component; however, such a technology raises an issue with increased cost due to having the two solid-state imaging apparatuses. Further, the technology of PTL 1 involving emission of light of a random pattern causes an issue that it takes much time to perform analysis for measuring a distance from image data after reflected light is imaged by the two solid-state imaging apparatuses, resulting in loss of instantaneousness necessary for biometric authentication.

PTL 1 describes a technology that avoids deterioration in ranging performance that is caused by zero-order light by disposing a pattern illuminator so that pattern light to be emitted to a measuring object contains no zero-order light generated by a diffractive optical element. However, the technology described in PTL 1 has raised the issue with increased cost because such a technology necessitates the use of two cameras (a stereo camera) that image a random pattern for ranging purpose. Further, as described in FIG. 8 in PTL 1, a position of the zero-order light is changed by varying a distance between cameras of the stereo camera to avoid an issue that the zero-order light is generated even in a case of the random pattern.

The technology described in PTL 2 represents an example of a solid-state imaging apparatus that achieves both of acquisition of color signals and ranging using a single camera; however, such patent literature fails to describe any means to avoid deterioration in the ranging performance caused by the zero-order light. Therefore, the deterioration in the ranging performance caused by the zero-order light generated by the diffractive optical element is unavoidable.

The technology described in PTL 3 intends to improve ranging accuracy by changing output light from the diffractive optical element into light of two different directions with use of an astigmatic lens. Such a technology necessitates the astigmatic lens along with the diffractive optical element, leading to increased cost. Further, PTL 3 also fails to describe any countermeasure against the zero-order light.

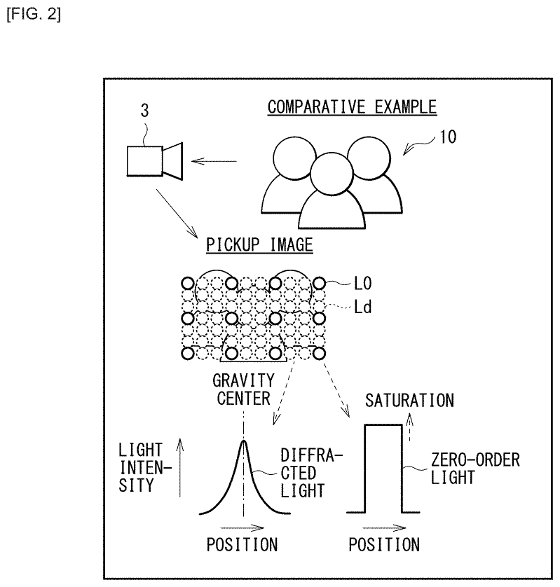

FIG. 1 schematically illustrates a configuration example of a light source system and a ranging system according to a first comparative example. FIG. 2 schematically illustrates an example of light intensity to be measured by the ranging system according to the first comparative example.

The ranging system according to the first comparative example includes a light source system including a light source 1 and a diffractive optical element 200, and an imaging camera 3.

The light source 1 irradiates the diffractive optical element 200 with collimated light including infrared light, for example. In the diffractive optical element 200, a predetermined pattern is formed that generates diffracted light Ld. The diffractive optical element 200 generates the diffracted light Ld from light emitted out from the light source 1. An object 10 is irradiated with the diffracted light Ld outputted from the diffractive optical element 200. Reflected light emitted to the light emitted to the object 10 is imaged by the imaging camera 3. The imaging camera 3 includes, for example, a solid-state imaging device. The imaging camera 3 stores and analyzes imaging data of the diffracted light Ld. It is a common practice to measure a distance to the object 10, a concavo-convex shape of the object 10, or the like by analyzing the diffracted light Ld inside the imaging camera 3.

However, the diffractive optical element 200 outputs not only the diffracted light Ld, but also light (zero-order light L0) that is not diffracted by the diffractive optical element 200, and the object 10 is irradiated with the zero-order light L0. Therefore, a pickup image acquired by the imaging camera 3 includes the diffracted light Ld and the zero-order light L0, as schematically illustrated in FIG. 2. Typically, light intensity of the zero-order light L0 is greater than light intensity of the diffracted light Ld. As a result, for example, in a case where exposure adjustment is performed in the imaging camera 3 by an electronic shutter, a mechanical shutter, a diaphragm, or the like to ensure that the diffracted light Ld other than the zero-order light L0 is optimally stored as imaging data, an issue has arisen that the zero-order light L0 increases in light intensity to cause the light intensity to be saturated, as schematically illustrated in FIG. 2.

As a method of analyzing a distance measurement by the ranging system according to the first comparative example in FIG. 1, a method is available that calculates a distance to the object 10 by obtaining a gravity center of a circle of reflected light of the diffracted light Ld emitted to the object 10, as illustrated in FIG. 2. In such a case, a method is adopted that avoids the use of a reflected light component of the zero-order light L0 in calculating a distance. However, it is obvious that non-use of the zero-order light L0 degrades resolution of ranging. Further, in a case where the exposure adjustment is performed in the imaging camera 3 by the electronic shutter, the mechanical shutter, the diaphragm, or the like to ensure that the zero-order light L0 is optimally stored as imaging data, it is obvious that the diffracted light Ld other than the zero-order light L0 deceases in intensity, which makes it difficult to calculate a distance.

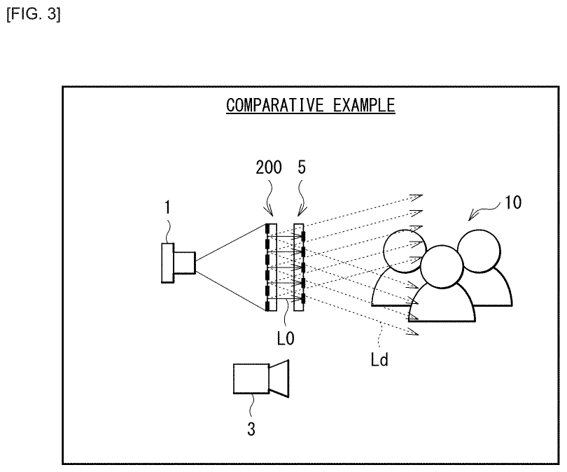

FIG. 3 schematically illustrates an example of a light source system and a ranging system according to a second comparative example.

The light source system according to the second comparative example additionally includes a zero-order light correcting element 5 for a countermeasure against the zero-order light, as compared with the ranging system according to the second comparative example in FIG. 1. The zero-order light correcting element 5 is provided separately from the diffractive optical element 200. The zero-order light correcting element 5 includes a pattern (a pattern reverse to the predetermined pattern formed on the diffractive optical element 200) that reduces the zero-order light L0 of the diffractive optical element 200 to reduce the zero-order light L0 from the diffractive optical element 200. However, in such a method, the diffractive optical element 200 and the zero-order light correcting element 5 are provided as separate elements, which raises an issue with difficulty in aligning the patterns formed on the both elements, resulting in a low yield.

### 1.1 Configuration and Operation of Light Source System and Ranging System According to First Embodiment

FIG. 4 schematically illustrates a configuration example of a light source system and a ranging system according to a first embodiment of the present disclosure. FIG. 5 schematically illustrates a cross-sectional configuration example and a planar configuration example of a diffractive optical element 2 according to the first embodiment. It is to be noted that, hereinafter, any components substantially the same as those in the light source system and the ranging system according to the above-described comparative examples are denoted with the same reference numerals, and the related descriptions are omitted as appropriate.

The ranging system according to the first embodiment includes a light source system including a light source 1 and a diffractive optical element 2, an imaging camera 3, a distance calculation section 31, a shape recognition section 32, and a biometric authentication section 33, as illustrated in FIG. 4.

The imaging camera 3 images reflected light of the diffracted light Ld that is outputted from the diffractive optical element 2 and emitted to the object 10, and generates image data. The distance calculation section 31 calculates a distance to the object 10 on the basis of the image data. The shape recognition section 32 determines a concavo-convex shape of a face or the like of the object 10 on the basis of distance data calculated by the distance calculation section 31 to perform shape recognition of the object 10. The biometric authentication section 33 performs biometric authentication such as facial recognition on the basis of a result of recognition performed by the shape recognition section 32.

The diffractive optical element 2 includes a glass substrate 20, a diffraction grating section 6, and a zero-order light correcting section 24, as illustrated in FIG. 5. The glass substrate 20 is disposed between the diffraction grating section 6 and the zero-order light correcting section 24.

The diffraction grating section 6 is formed on one surface 21 of the glass substrate 20. The diffraction grating section 6 includes openings that are formed in a predetermined pattern and that light from the light source 1 enters, and a light-blocking section 25 serving as a light-blocking member that blocks light. The diffraction grating section 6 generates the diffracted light Ld on the basis of entering light. In an example of FIG. 5, the openings in the predetermined pattern are circular holes, and the diffraction grating section 6 has a circular hole 23 as the opening.

The zero-order light correcting section 24 is formed on another surface 22 of the glass substrate 20 opposite to the one surface 21. The zero-order light correcting section 24 includes, for example, UV curable resin 41, as illustrated in FIG. 6 to be described later. The zero-order light correcting section 24 includes a neutral density (ND) pattern or a black pattern to reduce the zero-order light L0 generated in the diffraction grating section 6. This ensures that the diffractive optical element 2 has a function of adjusting the zero-order light L0, as compared with the diffractive optical element 200 in the comparative example (FIG. 1). The zero-order light correcting section 24 is formed in at least part of region corresponding to each opening (each circular hole 23) of the diffraction grating section 6, as viewed from an entering direction of light from the light source 1. Preferably, a size of the zero-order light correcting section 24 is substantially equal to or greater than a size of the opening of the diffraction grating section 6 to reduce the zero-order light L0. Further, it is preferable that a shape of the zero-order light correcting section 24 be also substantially the same as a shape of the opening of the diffraction grating section 6 to reduce the zero-order light L0. However, even if the zero-order light correcting section 24 is smaller in size than the opening of the diffraction grating section 6, an effect of reducing the zero-order light L0 is obtained. Therefore, the zero-order light correcting section 24 may be smaller in size than the opening of the diffraction grating section 6. Further, even if the zero-order light correcting section 24 is slightly different in shape from the opening of the diffraction grating section 6, the effect of reducing the zero-order light L0 is obtained. Therefore, the zero-order light correcting section 24 may be slightly different in shape from the opening of the diffraction grating section 6.

In FIG. 5, TOP VIEW illustrates a surface on the light source 1 side, and Bottom View illustrates a surface on the object 10 side. Collimated light including, for example, infrared light that is emitted from the light source 1 enters the diffractive optical element 2 from the TOP View. The diffractive optical element 2 outputs the diffracted light Ld generated by the diffraction grating section 6 to the object 10 from the Bottom View side. In a case where the diffractive optical element 2 is configured as illustrated in FIG. 5, the object 10 is irradiated with the circular diffracted light Ld because the diffraction grating section 6 has the circular hole 23 as the opening. Meanwhile, the zero-order light L0 generated in the diffraction grating section 6 is adjusted to reduce light intensity thereof by the zero-order light correcting section 24 that includes the ND pattern or the black pattern.

### 1.2 Method of Manufacturing Diffractive Optical Element According to First Embodiment

FIG. 6 illustrates an example of a method of manufacturing the diffractive optical element 2.

First, as illustrated in (A) of FIG. 6, a light-blocking member of black, for example, is formed in a predetermined pattern onto the one surface 21 of the glass substrate 20 by application. In such a manner, the light-blocking section 25 and the opening (the circular hole 23) that serve as the diffraction grating section 6 are formed on the one surface 21 of the glass substrate 20.

Next, the zero-order light correcting section 24 is formed on the other surface 22 of the glass substrate 20. In such a case, a pattern of the zero-order light correcting section 24 is preferably formed at a precise position facing the opening formed on the one surface 21. Therefore, subsequently, the liquid UV curable resin 41 is brought into contact with the other surface 22 opposite to the one surface 21 of the glass substrate 20, as illustrated in (B) of FIG. 6. The liquid UV curable resin 41 is colored into ND or black.

Thereafter, as illustrated in (C) of FIG. 6, the glass substrate 20 is irradiated with UV light from the one surface 21 side to harden the liquid UV curable resin 41 that is brought into contact with the other surface 22. The liquid UV curable resin 41 is hardened by the UV light (equivalent to the zero-order light L0 generated in the diffraction grating section 6) transmitting the opening formed on the one surface 21. This ensures that the zero-order light correcting section 24 of the ND pattern or the black pattern is formed on the other surface 22 in a region corresponding to the opening formed on the one surface 21. At the time, the UV curable resin 41 is likely to be semi-fixed and remain in a region on the other surface 22 other than the region corresponding to the opening formed on the one surface 21.

Finally, to deal with this, the other surface 22 of the glass substrate 20 is separated from the liquid UV curable resin 41 and cleaned, as illustrated in (D) and (E) of FIG. 6. This removes the semi-fixed and remaining liquid UV curable resin 41.

### (Modification Examples of Method of Manufacturing Diffractive Optical Element)

In the manufacturing method described above, when the zero-order light correcting section 24 is formed, hybrid curable resin containing thermosetting resin may be used instead of the UV curable resin 41.

Further, in the manufacturing method described above, the zero-order light correcting section 24 may be formed by performing cleaning after temporary fixing with use of the UV curable resin 41, and thereafter performing permanent fixing with use of the thermosetting resin. As an alternative, the zero-order light correcting section 24 may be formed by performing permanent fixing with use of the thermosetting resin after temporary fixing with use of the UV curable resin 41, and thereafter performing cleaning.

### 1.3 Modification Examples of Diffractive Optical Element According to First Embodiment

FIG. 7 schematically illustrates a cross-sectional configuration example and a planar configuration example of a diffractive optical element 2A according to a first modification example of the first embodiment. FIG. 8 schematically illustrates a cross-sectional configuration example and a planar configuration example of a diffractive optical element 2B according to a second modification example of the first embodiment.

FIG. 5 illustrates a configuration example where the diffraction grating section 6 has the circular holes 23 as the openings in the predetermined pattern; however, the predetermined pattern is not limited to the circular hole pattern, and may be, for example, a linear pattern or a random-formed pattern.

For example, as seen in the diffractive optical element 2A according to the first modification example as illustrated in FIG. 7, a diffraction grating section 6A formed on the one surface 21 may be configured to have a linear hole 23A as the opening in the predetermined pattern. In such a case, a zero-order light correcting section 24A corresponding to the linear hole 23A is formed in a linear pattern on the other surface 22.

Further, for example, as seen in the diffractive optical element 2B according to the second modification example as illustrated in FIG. 8, a diffraction grating section 6A formed on the one surface 21 may be configured to have a random hole 23B as the opening in the predetermined pattern. In such a case, a zero-order light correcting section 24B corresponding to the random hole 23B is formed in a random pattern on the other surface 22.

### 1.4 Effects

As described thus far, according to the light source system and the ranging system of the first embodiment, the diffractive optical element having the zero-order light correcting section is provided, which makes it possible to reduce intensity of zero-order light generated in the diffraction grating section. This allows for high-accuracy ranging by effectively adjusting the intensity of the zero-order light. This makes it possible to perform high-accuracy biometric authentication, for example.

It is to be noted that the effects described in the present specification are merely exemplified and non-limiting, and effects of the disclosure may be other effects, or may further include other effects. The same is applied to effects of other subsequent embodiments.

### 2. Second Embodiment

Next, description is provided of a light source system and a ranging system according to a second embodiment of the present disclosure. It is to be noted that, hereinafter, any components substantially the same as those in the light source system and the ranging system according to the above-described first embodiment are denoted with the same reference numerals, and the related descriptions are omitted as appropriate.

FIG. 9 schematically illustrates a configuration example of the light source system and the ranging system according to the second embodiment.

The light source system and the ranging system according to the second embodiment further includes a correcting lens 4 as well as the light source system and the ranging system according to the first embodiment. The correcting lens 4 is disposed between the light source 1 and the diffractive optical element 2 to correct light from the light source 1 into parallel light.

Typical ranging and biometric authentication use infrared light. The diffractive optical element 2 is preferably irradiated with the infrared light serving as collimated light. It is commonly known that a certain distance is necessary between the light source 1 and the diffractive optical element 2 to emit the high-accuracy collimated light from the light source 1. By disposing the correcting lens 4 between the light source 1 and the diffractive optical element 2, it is possible to reduce a distance between the light source 1 and the diffractive optical element 2.

Any other configuration, operation and effects may be substantially similar to those of the light source system and the ranging system according to the above-described first embodiment.

### 3. Other Embodiments

The technology according to the present disclosure is not limited to the descriptions of the above respective embodiments, but various modifications may be made.

In the above respective embodiments, an example case is described in which distance data calculated by the distance calculation section 31 is used for the biometric authentication; however, the distance data may be used for any application other than the biometric authentication.

Further, for example, the present technology may be configured as follows.

According to the technology configured in the following manner, it is possible to reduce intensity of zero-order light. Further, the technology allows for manufacturing a diffractive optical element that reduces the intensity of the zero-order light.

This application claims the priority on the basis of Japanese Patent Application No. 2018-050773 filed on Mar. 19, 2018 and Japanese Patent Application No. 2018-203709 filed on Oct. 30, 2018 with Japan Patent Office, the entire contents of which are incorporated in this application by reference.

(1) A light source system including:

a light source that emits light; and

a diffractive optical element that includes
a diffraction grating section that is formed on one surface, has an opening in a predetermined pattern, the light from the light source entering the opening, and generates diffracted light on a basis of the entering light, and
a zero-order light correcting section that is formed in at least part of region on another surface opposite to the one surface, the at least part of region corresponding to the opening as viewed from an entering direction of the light from the light source, and reduces zero-order light generated in the diffraction grating section.
   (2) The light source system according to (1), further including a correcting lens that is disposed between the light source and the diffractive optical element and corrects the light from the light source into parallel light.
   (3) The light source system according to (1) or (2), in which the zero-order light correcting section includes UV curable resin.
   (4) The light source system according to any one of (1) to (3), in which the predetermined pattern is any one of a circular hole form, a linear form, or a random form.
   (5) The light source system according to (3), in which the UV curable resin is hardened by being irradiated with UV light transmitting the diffraction grating section.
   (6) The light source system according to any one of (1) to (5), in which the diffractive optical element includes a substrate disposed between the diffraction grating section and the zero-order light correcting section.
   (7) A method of manufacturing a diffractive optical element, the method including:

forming a light-blocking member in a predetermined pattern on one surface of a substrate;

bringing liquid UV curable resin into contact with another surface opposite to the one surface of the substrate;

irradiating the substrate with UV light from side of the one surface; and

cleaning the other surface of the substrate.

(8) The method of manufacturing a diffractive optical element according to (7), in which

the irradiating with the UV light includes hardening the liquid UV resin in contact with the other surface.

(9) A ranging system including:

a light source that emits light;

a diffractive optical element that includes
a diffraction grating section that is formed on one surface, has an opening in a predetermined pattern, the light from the light source entering the opening, and generates diffracted light on a basis of entering light, and
a zero-order light correcting section that is formed in at least part of region on another surface opposite to the one surface, the at least part of region corresponding to the opening as viewed from an entering direction of the light from the light source, and reduces zero-order light generated in the diffraction grating section;

an imaging section that images reflected light of the diffracted light outputted from the diffractive optical element and emitted to an object, and generates image data; and

a distance calculation section that calculates a distance to the object on a basis of the image data.

(10) A diffractive optical element including:

a substrate;

a diffraction grating section that is formed on one surface of the substrate, has an opening in a predetermined pattern which light enters, and generates diffracted light on a basis of the entering light; and

a zero-order light correcting section that is formed in at least part of region on another surface of the substrate opposite to the one surface, the at least part of region corresponding to the opening as viewed from an entering direction of the light, and reduces zero-order light generated in the diffraction grating section.

It should be understood by those skilled in the art that various modifications, combinations, sub-combinations, and alterations may occur depending on design requirements and other factors insofar as they are within the scope of the appended claims or the equivalents thereof.

1. A light source system comprising:
a light source that emits light; and
a diffractive optical element that includes
a diffraction grating section that is formed on one surface, has an opening in a predetermined pattern, the light from the light source entering the opening, and generates diffracted light on a basis of the entering light, and
a zero-order light correcting section that is formed in at least part of region on another surface opposite to the one surface, the at least part of region corresponding to the opening as viewed from an entering direction of the light from the light source, and reduces zero-order light generated in the diffraction grating section.

2. The light source system according to claim 1, further comprising a correcting lens that is disposed between the light source and the diffractive optical element and corrects the light from the light source into parallel light.

3. The light source system according to claim 1, wherein the zero-order light correcting section includes UV curable resin.

4. The light source system according to claim 1, wherein the predetermined pattern comprises any one of a circular hole form, a linear form, or a random form.

5. The light source system according to claim 3, wherein the UV curable resin is hardened by being irradiated with UV light transmitting the diffraction grating section.

6. The light source system according to claim 1, wherein the diffractive optical element includes a substrate disposed between the diffraction grating section and the zero-order light correcting section.

7. A method of manufacturing a diffractive optical element, the method comprising:
forming a light-blocking member in a predetermined pattern on one surface of a substrate;
bringing liquid UV curable resin into contact with another surface opposite to the one surface of the substrate;
irradiating the substrate with UV light from side of the one surface; and
cleaning the other surface of the substrate.

8. The method of manufacturing a diffractive optical element according to claim 7, wherein
the irradiating with the UV light includes hardening the liquid UV resin in contact with the other surface.

9. A ranging system comprising:
a light source that emits light;
a diffractive optical element that includes
a diffraction grating section that is formed on one surface, has an opening in a predetermined pattern, the light from the light source entering the opening, and generates diffracted light on a basis of entering light, and
a zero-order light correcting section that is formed in at least part of region on another surface opposite to the one surface, the at least part of region corresponding to the opening as viewed from an entering direction of the light from the light source, and reduces zero-order light generated in the diffraction grating section;
an imaging section that images reflected light of the diffracted light outputted from the diffractive optical element and emitted to an object, and generates image data; and
a distance calculation section that calculates a distance to the object on a basis of the image data.

10. A diffractive optical element comprising:
a substrate;
a diffraction grating section that is formed on one surface of the substrate, has an opening in a predetermined pattern which light enters, and generates diffracted light on a basis of the entering light; and
a zero-order light correcting section that is formed in at least part of region on another surface of the substrate opposite to the one surface, the at least part of region corresponding to the opening as viewed from an entering direction of the light, and reduces zero-order light generated in the diffraction grating section.
